(19) United States
(12) Patent Application Publication
(10) Pub. No.: US 2019/0062603 A1
(43) Pub. Date: Feb. 28, 2019

(54) SEALANT, LIQUID CRYSTAL PANEL, LIQUID CRYSTAL DISPLAY, AND PRODUCTION METHOD OF THE SAME

(71) Applicants: BOE Technology Group Co., Ltd., Beijing (CN); Beijing BOE Optoelectronics Technology Co., Ltd., Beijing (CN)

(72) Inventors: Xiaojuan Wu, Beijing (CN); Huishun Chen, Beijing (CN)

(21) Appl. No.: 15/765,368

(22) PCT Filed: Sep. 14, 2017
(86) PCT No.: PCT/CN2017/101711

§ 371 Date: Apr. 2, 2018

(30) Foreign Application Priority Data
Feb. 24, 2017 (CN) 201710105884.0

(51) Int. Cl. C09J 9/00; G02F 1/1339; C09J 177/00; C09J 163/00; C09J 133/04; C09J 5/00

(52) U.S. Cl. CPC C09J 9/00; G02F 1/1339; C09J 177/00; C09J 163/00; C09J 133/04; C09J 2433/00; G02F 2202/025; G02F 2202/36; C09J 2205/31; C09J 2477/00; C09J 2463/00; C09J 5/00

(57) ABSTRACT

This disclosure provides a sealant, a liquid crystal panel, a liquid crystal display, and a production method. The sealant of this disclosure comprises a graphene-polymer composite and a sealant matrix, wherein the graphene-polymer composite comprises graphene filled in a polymer, wherein in the graphene-polymer composite, the graphene has a filling ratio of 10% to 50% by weight; wherein the graphene-polymer composite is dispersed in the sealant matrix uniformly, and with respect to total weight of the graphene-polymer composite and the sealant matrix, the sealant matrix has a weight fraction of 70% to 97%, and the graphene-polymer composite has a weight fraction of 3% to 30%.

### CROSS-REFERENCE TO RELATED APPLICATION

This application claims the priority and benefits of Chinese Patent Application No. 201710105884.0, entitled as “SEALANT, LIQUID CRYSTAL PANEL, LIQUID CRYSTAL DISPLAY, AND PRODUCTION METHOD OF THE SAME” and filed on Feb. 24, 2017, the contents of which are incorporated herein by reference in its entirety.

### TECHNICAL FIELD

This disclosure relates the technical field of liquid crystal display, in particular, to a sealant, a liquid crystal panel, a liquid crystal display, and a production method.

### BACKGROUND ART

With the rapid development of cellphones, customers are stricter and stricter in the appearance, property, display and weight of cellphones. Correspondingly, requirements on liquid crystal displays are coming to a higher level. Particularly, for the liquid crystal displays, narrower frames are required. The resolution is becoming higher. FHD, QHD, as well as 4K or 2K displays are being developed and used.

When a frame of a liquid crystal display is narrower, the width of the sealant will be narrower, and due to being heated unevenly during thermocuring, it tends to result in defects, such as too narrow sealant, or even sealant breakage, water vapor entry, etc.

When the resolution of the liquid crystal display is higher, the requirements on the Integrated Circuit (IC) are higher, and IC tends to generate heat more easily during working, so that the local temperature near the IC of the liquid crystal display increases significantly. When the temperature is close to the clear point of the liquid crystal or exceeds the clear point, the dielectric anisotropy of the liquid crystal fades away gradually, and the liquid crystal does not respond to the applied electric field. For a normally black FFS display, blackening defect of the display will occur in the light-on state. In particular, negative liquid crystals are often used to increase the transmittance of liquid crystal displays. However, in order to increase the response speed and decrease the operating voltage (Vₒₚ), negative liquid crystals generally have lower clear points, and thus high-resolution negative liquid crystal displays tend to exhibit blackening defect during a long time power-on state or a reliability test.

### SUMMARY

An aspect of this disclosure provides a sealant, comprising:

a graphene-polymer composite, which comprises graphene filled in a polymer, wherein in the graphene-polymer composite, the graphene has a filling ratio of 10% to 50% by weight; and

a sealant matrix,

wherein the graphene-polymer composite is dispersed in the sealant matrix uniformly, and with respect to total weight of the graphene-polymer composite and the sealant matrix, the sealant matrix has a weight fraction of 70% to 97%, and the graphene-polymer composite has a weight fraction of 3% to 30%. For example, with respect to total weight of the graphene-polymer composite and the sealant matrix, the sealant matrix may have a weight fraction of 75% to 97%, and the graphene-polymer composite may have a weight fraction of 3% to 25%; or, with respect to total weight of the graphene-polymer composite and the sealant matrix, the sealant matrix may have a weight fraction of 80% to 96%, and the graphene-polymer composite may have a weight fraction of 4% to 20%.

According to an embodiment of this disclosure, the polymer in the graphene-polymer composite may be selected from at least one of polyamide, an epoxy resin and polycaprolactone.

According to another embodiment of this disclosure, the graphene-polymer composite may be produced from polymer and graphene by a solution mixing process, a melt blending process, an in-situ polymerization process or an emulsion mixing process.

According to another embodiment of this disclosure, in the graphene-polymer composite, the graphene may have a filling ratio of 15% to 40% by weight, for example, 18% to 30% or 20% to 25%.

According to another embodiment of this disclosure, the sealant matrix comprises an epoxy acrylic resin, an acrylic resin, a thermocuring agent, a photoinitiator, an organic filler and a coupling agent. In an illustrative embodiment, with respect to the weight of the sealant, the sealant may comprise: the graphene-polymer composite, 10% to 25%; the epoxy acrylic resin, 20% to 30%; the acrylic resin, 30% to 35%; the thermocuring agent, 10% to 15%; the photoinitiator, 0.1% to 0.5%; the organic filler, 1% to 6%; and the coupling agent, 4% to 4.5%. In another illustrative embodiment, with respect to the weight of the sealant, the sealant may consist of: the graphene-polymer composite, 10% to 25%; the epoxy acrylic resin, 20% to 30%; the acrylic resin, 30% to 35%; the thermocuring agent, 10% to 15%; the photoinitiator, 0.1% to 0.5%; the organic filler, 1% to 6%; and the coupling agent, 4% to 4.5%.

Another aspect of this disclosure provides a liquid crystal panel comprising a color filter substrate and an array substrate, wherein the color filter substrate and the array substrate are bonded by the sealant mentioned above.

Still another aspect of this disclosure provides a liquid crystal display, wherein the liquid crystal display comprises the liquid crystal panel mentioned above.

Further another aspect of this disclosure provides a production method of a liquid crystal panel comprising a color filter substrate and an array substrate with liquid crystal dripping thereon, wherein the method comprises following steps:

subjecting the sealant mentioned above to a defoaming treatment under a lucifuge condition, to obtain a sealant undergone the defoaming treatment; coating the sealant undergone the defoaming treatment onto frames of the color filter substrate, to obtain a color filter substrate applied with the sealant; aligning and assembling the array substrate with liquid crystal dripping thereon and the color filter substrate applied with the sealant, to obtain an aligned and assembled product; and subjecting the aligned and assembled product to UV polymerization and thermal polymerization, to obtain the liquid crystal panel.

According to an embodiment of this disclosure, the defoaming treatment may have a duration of 1 to 5 h.

### DESCRIPTION OF DRAWINGS

In order to describe the technical solutions in examples of this disclosure more clearly, drawings needed to be used in illustration for examples will be described briefly below. Obviously, the drawings in the description below are only exemplary examples of this disclosure. For a person skilled in the art, other drawings may be obtained according to these drawings without inventive labor.

FIG. 1 is a schematic plan of a liquid crystal display, in which there is a graphene-polymer composite contained in the sealant.

FIG. 2 is a schematic drawing of a color filter substrate applied with a sealant and an array substrate with liquid crystal dripping thereon, prior to alignment.

FIG. 3 is a schematic flow chart of an embodiment of a method for producing a liquid crystal panel comprising a color filter substrate and an array substrate with liquid crystal dripping thereon, according to this disclosure.

### DETAILED EMBODIMENT

The technical solutions in examples of this disclosure will be clearly and fully described by incorporating detailed embodiments of this disclosure. Obviously, the embodiments and/or examples described only a part of embodiments and/or examples of this disclosure, but not all embodiments and/or examples. On the basis of the embodiments and/or examples in this disclosure, all other embodiments and/or examples obtained by a person skilled in the art without inventive labor belong to the protection scope of this disclosure.

In the following description, the ratio or percent are in term of weight, unless otherwise specifically indicated.

It is needed to provide a sealant, a liquid crystal panel, a liquid crystal display, and a production method thereof, in which the defects, such as sealant breakage, water vapor entry, etc. are prevented by allowing the sealant to be heated more evenly during thermocuring; meanwhile, local heat may be transferred to the whole screen of the liquid crystal display, so as to prevent significant increase of the local temperature, and thus preventing blackening defect during a long time power-on state or a reliability test.

In the sealant provided in an aspect of this disclosure, the sealant comprises a graphene-polymer composite. The graphene-polymer composite comprises graphene filled in a polymer, wherein in the graphene-polymer composite, the graphene has a filling ratio of 10% to 50% by weight.

The graphene-polymer composite is dispersed in the sealant matrix uniformly.

With respect to total weight of the graphene-polymer composite and the sealant matrix, the sealant matrix has a weight fraction of 70% to 97%, and the graphene-polymer composite has a weight fraction of 3% to 30%.

Graphene has perfect two-dimensional crystal structure, in which the crystal lattice consists of hexagons enclosed by six carbon atoms and has a thickness of one atom layer. Graphene is the thinnest and hardest one among known nano-materials, has a coefficient of thermal conductivity up to 5300 W/m·K, having an extremely high thermal conductivity.

The graphene-polymer composite in this disclosure is also referred to as graphene polymer high-thermoconductive composite. It has not only the good property of high thermoconductivity of graphene, but also properties, such as the machinability, solubility in organic materials, viscosity, or the like of a polymer. Meanwhile, the polymer allows graphene dispersing in the mixture more uniformly, which prevents the agglomeration phenomenon and makes the high thermoconductivity of the composite being more uniform. The polymer (also referred to as the substrate material) in the graphene polymer high-thermoconductive composite may be polyamide (PA), an epoxy resin (EP), polycaprolactone (PCL), and the like. The graphene polymer high-thermoconductive composite may be produced by a solution mixing process, a melt blending process, an in-situ polymerization process, an emulsion mixing process, or the like.

In a solution mixing process, the graphene is dispersed in a polymer solution. The examples of the solvent in the polymer solution may comprise acetone, dichloromethane, trichloromethane, and the like.

In a melt blending process, the graphene is dispersed in a melt of the polymer. The melt of the polymer may have a temperature of 80° C. to 250° C.

In an in-situ polymerization process, in-situ polymerization is performed in the case that the graphene is dispersed in the monomer or oligomer of the polymer. The initiator used in the polymerization may be polyvinylpyrrolidone, dianhydride diamine, aminocaproic acid, etc.

In an emulsion polymerization process, emulsion polymerization is performed in the case that the graphene is dispersed in an emulsion of the monomer or oligomer of the polymer. The initiator used in the polymerization may be polyvinylpyrrolidone, dianhydride diamine, aminocaproic acid, etc.

For a normal liquid crystal display having high resolution, during a long time power-on state or a reliability test, the IC tends to generate heat, so that the local temperature near the IC increases significantly. This part of heat affects the liquid crystal display gradually from the vicinity of the IC via the sealant, to increase the temperature of the liquid crystal in the liquid crystal display zone. When this temperature is close to the clear point of the liquid crystal or exceeds the clear point, the dielectric anisotropy of the liquid crystal decreases or disappears, and the liquid crystal responds to applied electric field weakly, so that the defect of blackening occurs.

For the liquid crystal display, in which a sealant having a graphene polymer high-thermoconductive composite is blended therein, during a long time power-on state or a reliability test, the IC tends to generate heat, so that the local temperature near the IC increases significantly. This part of heat from the vicinity of the IC becomes firstly in contact with the sealant. Since the graphene polymer high-thermoconductive composite having highly conductivity is contained in the sealant, the heat may be dispersed uniformly in the whole screen via the sealant rapidly, so that the temperature of the whole screen changes little. The crystal liquid will not be affected by this heat, and responds to the action of the electric field normally. That is to say, the liquid crystal display may display normally, so as to prevent the occurrence of the blackening defect.

For a liquid crystal display with narrow frames, since the sealant is very narrow, due to being heated unevenly during thermocuring, it tends to result in defects, such as too narrow sealant, or even sealant breakage, water vapor entry, etc. For the liquid crystal display, in which a sealant having a graphene polymer high-thermoconductive composite is blended therein, during the thermocuring of the sealant, the graphene polymer high-thermoconductive composite contained in the sealant allows all positions of the sealant are heated uniformly, so as to prevent occurrence of defects, such as sealant breakage. Meanwhile, since the graphene exhibits relatively high hydrophobicity, the addition of the graphene polymer high-thermoconductive composite in the sealant may prevent water vapor entering the display via the sealant, and thereby preventing defects, such as peeling off, frame Mura, etc.

In the graphene-polymer composite, the graphene may have a filling ratio of 10% to 50% by weight, for example, 10% to 40%, for example, with a lower limit which may be 11%, 13%, 15%, 18%, 20%, 22%, 24%, 25%, etc., and with a upper limit which may be 50%, 48%, 45%, 40%, 35%, 32%, 30%, 28%, etc. For example, in the graphene-polymer composite, the graphene may have a filling ratio of 15% to 45%, 18% to 30%, or 20% to 25%.

With respect to total weight of the graphene-polymer composite and the sealant matrix, the sealant matrix may have a weight fraction of 70% to 97%, 72% to 97%, 75% to 97%, 75% to 96%, 80% to 96%, or 85% to 96%, and the graphene-polymer composite may have a weight fraction of 3% to 30%, 3% to 28%, 3% to 25%, 4% to 25%, 4% to 20%, or 4% to 15%.

In the sealant provided by embodiments of this disclosure, the specific composition of the sealant matrix is not particularly defined, and may be conventional technical means in the art. A person skilled in the art may understand that the sealant matrix may comprise at least epoxy acrylic resin, an acrylic resin, thermocuring agent, a photoinitiator, an organic filler, as well as a coupling agent.

The epoxy acrylic resin may be obtained by reacting epoxy resin and acrylic acid. It is a resin of thermocuring type, and has good properties of the epoxy resin. The epoxy resin used to be reacted with the acrylic acid to produce the epoxy acrylic resin may be a phenolic epoxy resin, such as epoxy resins with the trademarks E21, E44, E51, F44, F51, and the like.

The acrylic resin may be a resin produced by copolymerization of (meth)acrylic acid-, (meth)acrylate- and other olefin-based monomers. Since there is a double bond in the molecular structure of the acrylic resin, the acrylic resin may be cured due to the free radical polymerization induced by a photoinitiator under irradiation of UV light. (Meth)acrylate-based monomer may be methyl (meth)acrylate, ethyl (meth)acrylate, propyl (meth)acrylate, butyl (meth)acrylate, and the like, but not limited by the above-mentioned types. Said other olefin-based monomer may be styrene, α-methylstyrene, vinyl toluene, vinyl xylene, divinyl benzene, divinyl toluene, and the like, but not limited by the above-mentioned types.

Examples of the thermocuring agent may comprise an amine-based curing agent including, but not limited to, an aliphatic amine-based curing agent, such as ethylene diamine, diethylene triamine, and the like, an aromatic amine-based curing agent, such as m-phenylenediamine, m-xylylene diamine, diamino diphenyl methane, and the like, or a modified amine-based curing agent, such as O-hydroxyethyl ethylene diamine, and the like.

Examples of the photoinitiator may comprise an acetophenone-based photoinitiator, including but not limited to, acetophenone, 2,2-dimethoxy-2-phenylacetophenone, 2,2-diethoxy-2-phenylacetophenone, and 1,1-dichloroacetophenone.

The organic filler may be used to adjusting the physical and chemical properties of the sealant, such as shrinkage factor, expansion rate, toughness, etc., in order to allow it having very good ductility and improving the bonding force. For example, it may be a resin particle having a core-shell structure. The core particle of the resin particle is formed of a resin having rubber elasticity, and the shell layer of the resin particle is formed of a resin having a glass temperature of 120 to 150° C. A resin particle having the above-mentioned properties may be produced of a polymer of an acrylic monomer.

The coupling agent may increase the bonding force between the sealant and the substrate, to ensure the bonding effect between the color filter substrate and the array substrate. The coupling agent may be a silane coupling agent, such as vinyltrichlorosilane, vinyltriethoxysilane, vinyltrimethoxysilane, phenyltrichlorosilane, diphenyldimethoxysilane, 3-aminopropyltriethoxysilane, 3-aminopropyltrimethylsilane, methyldichlorosilane, methyldimethoxysilane, dimethyldichlorosilane, dimethyldimethoxysilane, dimethyldiethoxysilane, or the like. However, it is not limited to the types mentioned above.

The specific types of the above-mentioned epoxy acrylic resin, acrylic resin, thermocuring agent, photoinitiator, organic filler, and silane coupling agent may be selected according to practical requirements.

Examples of commercial sealant matrixes may include SWB-73 and SUR-66 available from Sekisui Chemical.

With respect to the weight of the sealant, the sealant may comprise or substantially consist of: the graphene-polymer composite, 10% to 25%; the epoxy acrylic resin, 20% to 30%; the acrylic resin, 30% to 35%; the thermocuring agent, 10% to 15%; the photoinitiator, 0.1% to 0.5%; the organic filler, 1% to 6%; and the coupling agent, 4% to 4.5%.

The sealant of this disclosure may further comprise other components, for example, another conductive material, such as graphene oxide and ethylene-vinyl acetate copolymer.

Since the graphene oxide has relatively high hardness and good electrical conductivity, it may replace traditional glass fibers and gold ball particles to support the substrate and conduct electricity. In this case, since the graphene oxide has a layer structure, it exhibits a distribution structure having multiple layers, which may effectively prevent small molecules from passing, and thus effectively avoid the puncture phenomenon of the liquid crystal molecule. Meanwhile, since the graphene oxide has good hydrophilicity and the other components of the sealant also have hydrophilicity, the graphene oxide may be dispersed in the sealant uniformly, so that the supporting forces at all sites in the sealant are uniform and the gap defect is avoided, thereby overcoming the problem that the puncture phenomenon of the liquid crystal molecule occurs due to the uneven distribution of the traditional glass fibers and gold ball particles. Additionally, the graphene oxide may further enhance the viscosity of the sealant, to anchor the liquid crystal molecule, so that the puncture thereof is further prevented. On the basis of the effects mentioned above, the sealant provided in the embodiments and examples of this disclosure may effectively prevent occurrence of the puncture phenomenon of the liquid crystal molecule, and thus ensure the display effect of the liquid crystal panel.

The weight average molecular weight of the ethylene-vinyl acetate copolymer may be, for example, 10000-100000. The mass percent of the vinyl acetate in the ethylene-vinyl acetate copolymer is 5% to 45% or 20% to 28%. Since the ethylene-vinyl acetate copolymer is a polymer with high molecular weight, it has a good sealing property and a good bonding property, has relatively high molecular weight, exhibits a linear configuration, and may form a network structure. The small molecule monomers in the fundamental components of the sealant are affected by a relatively strong anchoring force in this network, so that they can hardly move. Thus, the contamination of the liquid crystal by the small molecule monomers in the fundamental components of the sealant, such as monomers for UV polymerization, monomers for thermal polymerization, or other components, is reduced.

The sealants having the components and formulations mentioned above have good bonding property. It allows that the heat may be dispersed uniformly in the whole screen via the sealant rapidly, so that the temperature of the whole screen changes little, while the color filter substrate and the array substrate may be bonded firmly. The crystal liquid will not be affected by this heat, and responds to the action of the electric field normally. That is to say, the liquid crystal display may display normally, so as to prevent the occurrence of the blackening defect. Additionally, since the graphene exhibits relatively high hydrophobicity, it may prevent water vapor entering the display via the sealant, and thereby preventing defects, such as peeling off, frame Mura, etc.

Another aspect of this disclosure may provide a liquid crystal panel comprising a color filter substrate and an array substrate, wherein the color filter substrate and the array substrate are bonded by the sealant mentioned above.

Still another aspect of this disclosure provides a liquid crystal display, wherein the liquid crystal display comprises the liquid crystal panel mentioned above.

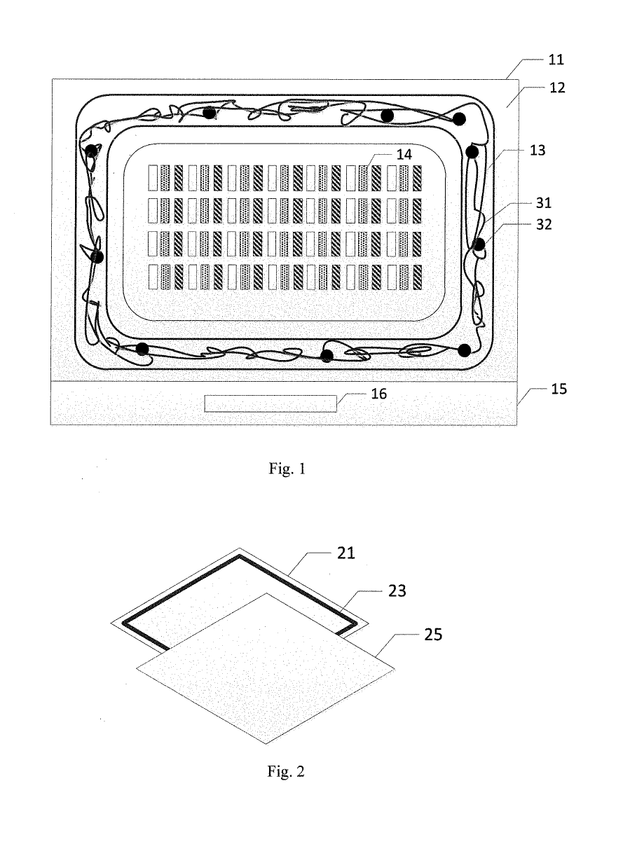

FIG. 1 is a schematic plan of a liquid crystal display, in which there is a graphene-polymer composite contained in the sealant. As shown in FIG. 1, the liquid crystal display comprises a color filter substrate edge 11 and a black matrix BM 12. The sealant 13 is coated on the color filter substrate edge 11. The sealant 13 has a graphene polymer high-thermoconductive composite 31. The graphene polymer high-thermoconductive composite 31 has graphene 32. The liquid crystal display has an active area zone (AA zone) 14. The array substrate (TFT substrate) with liquid crystal dripping thereon has a TFT substrate edge 15. The sealant 13 is located between the color filter substrate edge 11 and the TFT substrate edge 15. The integrate circuit (IC) 16 of the liquid crystal display generate heat.

FIG. 2 is a schematic drawing of a color filter substrate applied with a sealant and an array substrate with liquid crystal dripping thereon, prior to alignment. As shown in FIG. 2, the color filter substrate 21 is applied with the sealant 23. The array substrate 25 with liquid crystal dripping thereon and the color filter substrate 21 applied with the sealant will be aligned.

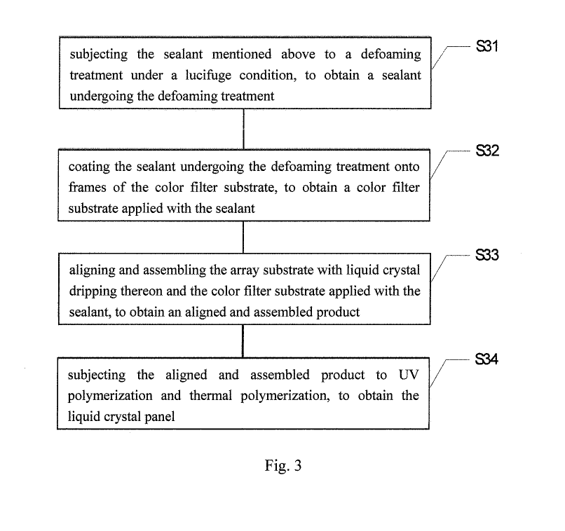

Further another aspect of this disclosure provides a production method of a liquid crystal panel comprising a color filter substrate and an array substrate with liquid crystal dripping thereon. FIG. 3 is a schematic flow chart of an embodiment of a method for producing a liquid crystal panel comprising a color filter substrate and an array substrate with liquid crystal dripping thereon, according to this disclosure.

The method for producing a liquid crystal panel comprising a color filter substrate and an array substrate with liquid crystal dripping thereon comprises Steps S31, S32, S33 and S34.

As shown in FIG. 3, in Step S31 the sealant mentioned above is subjected to a defoaming treatment under a lucifuge condition, to obtain a sealant undergone the defoaming treatment. Then, in Step S32 the sealant undergone the defoaming treatment is coated onto frames of the color filter substrate, to obtain a color filter substrate applied with the sealant. In Step S33, the array substrate with liquid crystal dripping thereon and the color filter substrate applied with the sealant is aligned and assembled, to obtain an aligned and assembled product. In Step S34, the aligned and assembled product is subjected to UV polymerization and thermal polymerization, to obtain the liquid crystal panel.

The conditions of the UV polymerization may be the followings: UV at 400 nm or less, for example, 365 nm; irradiation intensity: 5000 to 20000 mj/cm².

The conditions of the thermal polymerization may be the followings: temperature: 100 to 150° C.; duration: 40 min to 80 min.

The width of the coated sealant may be 0.3 mm to 2.0 mm.

According to an embodiment of this disclosure, the duration of the defoaming treatment may be 1 to 5 h, or 1.5 to 4 h, for example, 2 h or 2.5 h.

By means of the sealant of this disclosure, the heat may be dispersed uniformly in the whole screen via the sealant rapidly, so that the temperature of the whole screen changes little. The crystal liquid will not be affected by this heat, and responds to the action of the electric field normally. That is to say, the liquid crystal display may display normally, so as to prevent the occurrence of the blackening defect. Additionally, since the graphene exhibits relatively high hydrophobicity, it may prevent water vapor entering the display via the sealant, and thereby preventing defects, such as peeling off, frame Mura, etc.

### EXAMPLES

In Examples below, the parts and proportions are in term of weight, unless otherwise specifically indicated. The Examples are used for the purpose of exemplification, and should not be regarded as limiting the scope of this disclosure.

Materials used in the Examples are followings:

polyamide: purchased from Anqing Hongyu Chemical Industry Co. Ltd., HY-608 and HY-545;

epoxy resin: purchased from Wuxi Changgan Chemical Industry Co. Ltd., Epoxy Resin X80;

graphene: purchased from Zhuhai Jutan Composite, CPG-1508 and CPG-1606;

sealant matrix: purchased from Sekisui Chemical, SWB-73 and SUR-66.

### Example 1

(a) A graphene polymer high-thermoconductive composite was produced by a solution mixing process from polyamide HY-608 and graphene CPG-1508, wherein the filling ratio of the graphene was 20%;

(b) the sealant matrix SWB-73 (purchased from Sekisui) and the graphene polymer high-thermoconductive composite in (a) were blended uniformly at the weight ratio of 95 wt. %/5 wt. %;

(c) the mixture of the sealant matrix and the graphene polymer high-thermoconductive composite was placed into a defoaming machine and subjected to defoaming treatment under a lucifuge condition, wherein the defoaming time was 2 h;

(d) the mixture from (c) was applied onto a color filter (CF) substrate, the operation was performed under a lucifuge condition, until the mixture was applied uniformly; and

(e) the TFT substrate with liquid crystal dipped thereon and the CF substrate applied with the sealant mixture were aligned, and then the UV polymerization and thermal polymerization were performed, to produce a liquid crystal panel.

### Example 2

(a) A graphene polymer high-thermoconductive composite was produced by a melt blending process from epoxy resin X80 and graphene CPG-1606, wherein the filling ratio of the graphene was 25%;

(b) the sealant matrix SUR-66 (purchased from Sekisui) and the graphene polymer high-thermoconductive composite in (a) were blended uniformly at the weight ratio of 90 wt. %/10 wt. %;

(c) the mixture of the sealant matrix and the graphene polymer high-thermoconductive composite was placed into a defoaming machine and subjected to defoaming treatment under a lucifuge condition, wherein the defoaming time was 2.5 h;

(d) the mixture from (c) was applied onto a CF substrate, the operation was performed under a lucifuge condition, until the mixture was applied uniformly; and

(e) the TFT substrate with liquid crystal dipped thereon and the CF substrate applied with the sealant mixture were aligned, and then the UV polymerization and thermal polymerization were performed, to produce a liquid crystal panel.

### Example 3

Example 1 was repeated, except that in the graphene-polymer composite, the graphene had a filling ratio of 40% by weight, and the polyamide was HY-545.

### Example 4

Example 1 was repeated, except that the weight ratio of the graphene-polymer composite to the sealant matrix was 15/85.

### Example 5

Example 2 was repeated, except that in the graphene-polymer composite, the graphene had a filling ratio of 22.5% by weight.

### Example 6

Example 2 was repeated, except that the weight ratio of the graphene-polymer composite to the sealant matrix was 20/80.

### Comparative Example 1

(a) A sealant matrix SUR-66 (purchased from Sekisui) and graphene were blended uniformly at the weight ratio of 99 wt. %/1 wt. %;

(b) the mixture of the sealant matrix and the graphene was placed into a defoaming machine and subjected to defoaming treatment under a lucifuge condition, wherein the defoaming time was 2.5 h;

(c) the mixture from (b) was applied onto a CF substrate, the operation was performed under a lucifuge condition, until the mixture was applied uniformly; and

(d) the TFT substrate with liquid crystal dipped thereon and the CF substrate applied with the sealant mixture were aligned, and then the UV polymerization and thermal polymerization were performed, to produce a liquid crystal panel.

### Comparative Example 2

Example 1 was repeated, except that in the graphene-polymer composite, the graphene had a filling ratio of 60% by weight

### Comparative Example 3

Example 1 was repeated, except that the weight ratio of the graphene-polymer composite to the sealant matrix was 2/98.

### Comparative Example 4

Example 2 was repeated, except that in the graphene-polymer composite, the graphene had a filling ratio of 5% by weight.

### Comparative Example 5

Example 2 was repeated, except that the weight ratio of the graphene-polymer composite to the sealant matrix was 35/65.

It was found by examination that the graphene in the liquid crystal panels obtained in Examples 1 to 6 was dispersed in the cured sealant uniformly, without agglomeration. The heat may be dispersed uniformly in the whole screen via the sealant rapidly, so that the temperature of the whole screen changes little. The crystal liquid would not be affected by this heat, and responds to the action of the electric field normally. That is to say, the liquid crystal display may display normally, so as to prevent the occurrence of the blackening defect. Additionally, since the graphene exhibits relatively high hydrophobicity, it may prevent water vapor entering the display via the sealant, and thereby preventing defects, such as peeling off, frame Mura, etc.

In Comparative Example 1, it was found that the graphene agglomerated in the sealant. In Comparative Examples 2 and 5, the bonding property of the sealant was relatively poor. In Comparative Examples 3 and 4, the content of the graphene was less, and the graphene was discontinuous in the sealant.

When the filling ratio of the graphene in the graphene polymer high-thermoconductive composite was less than 10%, the improvement of the thermal conductivity of the composite was limited. When this filling ratio was greater than 50%, the filling amount was too large, the graphene tended to agglomerate, and the compatibility between the polymer and the sealant became worse. When the content of the graphene-polymer composite in the sealant was <3%, the improvement for the defects of the sealant was limited. When this content was >30%, the content was too much, which influenced the bonding property of the sealant.

The sealant of this disclosure has high thermal conductivity, which may prevent the occurrence of the blackening defects of the liquid crystal panel, and has high hydrophobicity, which may prevent water vapor entering the display via the sealant, and thereby preventing defects, such as peeling off, frame Mura, etc. Further, it may prevent the graphene from agglomeration.

It is apparent that a person skilled in the art may perform various changes and modifications to the Examples of this disclosure without departing from the spirit and scope of this disclosure. Thus, when these changes and modifications pertain to the scope of the claims and equivalent technology thereof in this disclosure, it is intended that these changes and modifications are included in this disclosure.

1. A sealant, comprising:
a graphene-polymer composite, which comprises graphene filled in a polymer, wherein in the graphene-polymer composite, the graphene has a filling ratio of 10% to 50% by weight; and
a sealant matrix,
wherein the graphene-polymer composite is dispersed in the sealant matrix uniformly, and with respect to total weight of the graphene-polymer composite and the sealant matrix, the sealant matrix has a weight fraction of 70% to 97%, and the graphene-polymer composite has a weight fraction of 3% to 30%.

2. The sealant according to claim 1, wherein the polymer in the graphene-polymer composite is selected from at least one of polyamide, an epoxy resin and polycaprolactone.

3. The sealant according to claim 1, wherein the graphene-polymer composite is produced from polymer and graphene by a solution mixing process, a melt blending process, an in-situ polymerization process or an emulsion mixing process.

4. The sealant according to claim 1, wherein in the graphene-polymer composite, the graphene has a filling ratio of 15% to 40% by weight.

5. The sealant according to claim 1, wherein in the graphene-polymer composite, the graphene has a filling ratio of 18% to 30% by weight.

6. The sealant according to claim 1, wherein in the graphene-polymer composite, the graphene has a filling ratio of 20% to 25% by weight.

7. The sealant according to claim 1, wherein with respect to total weight of the graphene-polymer composite and the sealant matrix, the sealant matrix has a weight fraction of 75% to 97%, and the graphene-polymer composite has a weight fraction of 3% to 25%.

8. The sealant according to claim 1, wherein with respect to total weight of the graphene-polymer composite and the sealant matrix, the sealant matrix has a weight fraction of 80% to 96%, and the graphene-polymer composite has a weight fraction of 4% to 20%.

9. The sealant according to claim 1, wherein the sealant matrix comprises an epoxy acrylic resin, an acrylic resin, a thermocuring agent, a photoinitiator, an organic filler and a coupling agent.

10. The sealant according to claim 9, wherein with respect to the weight of the sealant, the sealant comprises:
the graphene-polymer composite, 10% to 25%;
the epoxy acrylic resin, 20% to 30%;
the acrylic resin, 30% to 35%;
the thermocuring agent, 10% to 15%;
the photoinitiator, 0.1% to 0.5%;
the organic filler, 1% to 6%; and
the coupling agent, 4% to 4.5%.

11. The sealant according to claim 9, wherein with respect to the weight of the sealant, the sealant consists of:
the graphene-polymer composite, 10% to 25%;
the epoxy acrylic resin, 20% to 30%;
the acrylic resin, 30% to 35%;
the thermocuring agent, 10% to 15%;
the photoinitiator, 0.1% to 0.5%;
the organic filler, 1% to 6%; and
the coupling agent, 4% to 4.5%.

12. A liquid crystal panel comprising a color filter substrate and an array substrate, wherein the color filter substrate and the array substrate are bonded by the sealant of claim 1.

13. A liquid crystal display, wherein the liquid crystal display comprises the liquid crystal panel of claim 12.

14. A production method of a liquid crystal panel comprising a color filter substrate and an array substrate with liquid crystal dripping thereon, wherein the method comprises following steps:
subjecting the sealant of claim 1 to a defoaming treatment under a lucifuge condition, to obtain a sealant undergone the defoaming treatment;
coating the sealant undergone the defoaming treatment onto frames of the color filter substrate, to obtain a color filter substrate applied with the sealant;
aligning and assembling the array substrate with liquid crystal dripping thereon and the color filter substrate applied with the sealant, to obtain an aligned and assembled product; and
subjecting the aligned and assembled product to UV polymerization and thermal polymerization, to obtain the liquid crystal panel.

15. The method according to claim 14, wherein the defoaming treatment has a duration of 1 to 5 h.

16. The method according to claim 14, wherein the polymer in the graphene-polymer composite is selected from at least one of polyamide, an epoxy resin and polycaprolactone.

17. The method according to claim 14, wherein in the graphene-polymer composite, the graphene has a filling ratio of 15% to 40% by weight.

18. The method according to claim 14, wherein with respect to total weight of the graphene-polymer composite and the sealant matrix, the sealant matrix has a weight fraction of 75% to 97%, and the graphene-polymer composite has a weight fraction of 3% to 25%.

19. The method according to claim 14, wherein before the defoaming treatment, with respect to the weight of the sealant, the sealant comprises:
the graphene-polymer composite, 10% to 25%;
the epoxy acrylic resin, 20% to 30%;
the acrylic resin, 30% to 35%;
the thermocuring agent, 10% to 15%;
the photoinitiator, 0.1% to 0.5%;
the organic filler, 1% to 6%; and
the coupling agent, 4% to 4.5%.

20. The method according to claim 14, wherein before the defoaming treatment, with respect to the weight of the sealant, the sealant consists of:
the graphene-polymer composite, 10% to 25%;
the epoxy acrylic resin, 20% to 30%;
the acrylic resin, 30% to 35%;
the thermocuring agent, 10% to 15%;
the photoinitiator, 0.1% to 0.5%;
the organic filler, 1% to 6%; and
the coupling agent, 4% to 4.5%.
